(19) United States
(12) Patent Application Publication
(10) Pub. No.: US 2009/0206723 A1
(43) Pub. Date: Aug. 20, 2009

(54) WATER-BASED COMPOSITION FOR PREPARING ELECTRON EMITTER AND EMITTER PREPARED USING THE SAME

(75) Inventors: Yoon-Jin KIM, Suwon-si (KR); Jae-Myung Kim, Suwon-si (KR); Kyu-Nam Joo, Suwon-si (KR); Hyun-Ki Park, Suwon-si (KR); So-Ra Lee, Suwon-si (KR); Hee-Sung Moon, Suwon-si (KR)

Correspondence Address: STEIN MCEWEN, LLP, 1400 EYE STREET, NW, SUITE 300, WASHINGTON, DC, 20005, US

(73) Assignee: Samsung SDI Co., Ltd., Suwon-si (KR)

(21) Appl. No.: 12/345,995

(22) Filed: Dec. 30, 2008

(30) Foreign Application Priority Data
Feb. 20, 2008 (KR) 2008-15475

(51) Int. Cl. H01J 1/02; H01B 1/04; H01B 1/18

(52) U.S. Cl. 313/311; 252/502; 252/508; 977/742

(57) ABSTRACT

A water-based composition is used to form an electron and includes a carbonaceous compound, a silicate compound, and water. The electron emitter includes a carbonaceous compound and a silicate compound and is prepared using the water-based composition, and an electron emission device includes the electron emitter. The water-based composition that is used to form an electron emitter is suitable for forming a distinctive pattern, and the electron emitter prepared using the water-based composition has very small residual carbon content.

### CROSS-REFERENCE TO RELATED APPLICATION

This application claims the benefit of Korean Application No. 2008-15475, filed Feb. 20, 2008, in the Korean Intellectual Property Office, the disclosure of which is incorporated herein by reference.

### BACKGROUND OF THE INVENTION

1. Field of the Invention

Aspects of the present invention relate to a water-based composition used to form an electron emitter and which includes a carbonaceous compound, a silicate compound, and water, an electron emitter prepared using the water-based composition, and an electron emission device including the electron emitter, and more particularly, to a water-based composition used to form an electron emitter and which is suitable for forming a distinctive or cleanly delineated pattern, an electron emitter prepared using the water-based composition in which a content of a residual carbon is very small, and an electron emission device including the electron emitter.

2. Description of the Related Art

In general, electron emission devices are categorized into a hot electrode-type electron emission device in which a hot electrode acts as an electron emitter, and a cold electrode-type electron emission device in which a cold electrode acts as an electron emitter. Examples of the cold electrode-type electron emission device are a field emitter array (FEA)-type electron emission device, a surface conduction emitter (SCE)-type electron emission device, a metal insulator metal (MIM)-type electron emission device, a metal insulator semiconductor (MIS)-type electron emission device, and a ballistic electron surface emitting (BSE)-type electron emission device.

The FEA-type electron emission device is operated based on a principle that when an electron emitter is formed of a material having a low work function or a high beta function, electrons are easily emitted due to a field difference in a vacuum condition. Currently, an electron emission device including a tip structure formed of Mo or Si, and having a sharp end portion as an electron emitter, is being developed. Additionally, an electron emission device including an electron emitter formed of a carbonaceous material, such as graphite or diamond like carbon (DLC), and an electron emission device including an electron emitter formed of a nanomaterial, such as a nano tube or a nano wire, are being developed.

Additionally, FEA-type electron emission devices are categorized into a top gate-type electron emission device and an under gate-type electron emission device according to a configuration of a cathode and a gate electrode. FEA-electron emission devices can also be categorized into a diode-type electron emission device, a triode-type electron emission device, and a quadode-type electron emission device according to a number of electrodes used. FIG. 1 is a perspective view of an FEA-type electron emission device.

When an electron emitter that emits electrons is formed in the electron emission devices as described above, specifically, in a parallel lateral gate-type electron emission device in which a cathode electrode faces a gate electrode, a plurality of photolithography processes are used to form a sacrificial layer between the cathode and the gate electrode, or a sacrificial layer between the cathode and the electron emitting portion. When the cathode is formed as a thick layer, complicated photolithography processes are required. When the cathode is formed to be thick using Ag paste, an organic photoresist material can be used to form the sacrificial layer. However, the organic photoresist material reacts with the Ag paste at the interface between the sacrificial layer, formed of the organic photoresist material, and the cathode, and thus, a distinctive or cleanly delineated pattern cannot be obtained.

In general, a composition that is used to form an electron emitter, which is used in the process described above, includes a photosensitive component that remains as a residual carbon after a sintering process is performed, and adversely affects the performance and lifetime of an electron emission device.

### SUMMARY OF THE INVENTION

Aspects of the present invention includes a water-based composition used to form an electron emitter and suitable for forming a cleanly delineated pattern, an electron emitter prepared using the water-based composition in which the content of the residual carbon is very small, and an electron emission device including the electron emitter.

According to an aspect of the present invention, a water-based composition that is used to form an electron emitter includes a carbonaceous compound, a silicate compound, and water.

According to another aspect of the present invention, an electron emitter includes a carbonaceous compound and a silicate compound.

According to another aspect of the present invention, an electron emission device includes the electron emitter.

According to another aspect of the present invention, a method of forming an electron emitter of a field emitter array (FEA) electron emission device includes forming a photoresist between electrode patterns on a substrate of the electron emission device; coating a water based composition between the photoresist and the electrode patterns on the substrate to form a layer from which the electron emitter is formed; drying the water based composition that is coated on the substrate; removing the photoresist; and sintering the substrate to obtain the electron emitter from the water based composition on the substrate.

According to another aspect of the present invention a field emitter array (FEA) electron emission device includes a substrate; electrode patterns formed on the substrate; and an electron emitter formed from a water based composition, and having a gap formed by removal of a photoresist.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and advantages of the invention will become apparent and more readily appreciated from the following description of the aspects, taken in conjunction with the accompanying drawings of which:

FIG. 1 is a schematic perspective view of a typical electron emission device;

FIG. 2A is a perspective view of a photoresist coated between electrode patterns for a lateral-gate electron emitter formed on a substrate, and an enlarged view of the coated photoresist according to an aspect of the present invention;

FIG. 2B is a perspective view of a water-based composition coated on the substrate on which the electrode patterns for the lateral-gate electron emitter are formed according to an aspect of the present invention;

FIG. 2C is a perspective view of an electron emitter formed by lifting off the coated photoresist, after a sintering process is performed, and an enlarged view of a cross section of the electron emitter, according to an aspect of the present invention;

FIG. 2D is a sectional view of the electron emitter of FIG. 2C being a line sequential operation emitter;

FIG. 3 is a scanning electron microscopic (SEM) image of a photoresist pattern coated with a water-based composition that is used to form an electron emitter according to an aspect the present invention; and

FIG. 4 is an optical image of electron emitters facing each other after a photoresist is removed according to an aspect of the present invention;

FIG. 5 is an SEM image of a cross section of the interface between an electron emitter prepared using a typical organic composition and a photoresist; and

FIG. 6 is a graph of current density with respect to an electric field of the electron emission device prepared according to Example 2 and the electron emission device prepared according to Comparative Example 2.

### DETAILED DESCRIPTION OF THE EMBODIMENTS

Reference will now be made in detail to aspects of the present invention, examples of which are illustrated in the accompanying drawings, wherein like reference numerals refer to the like elements throughout. The aspects are described below in order to explain the present invention by referring to the figures.

A water-based composition that is used to form an electron emitter according to aspects of the present invention includes a carbonaceous compound, a silicate compound, and water. The carbonaceous compound of the water-based composition may be carbon nanotubes, carbide-driven (or based) carbon, or a mixture thereof.

Carbon nanotubes are an allotrope of carbon that includes graphite sheets rolled up into a nano size diameter to form a tube or a tube-like shape, and may be single wall (or sheet) nanotubes, multi wall (or sheets) nanotubes, or a mixture thereof, but are not limited thereto. Carbon nanotubes according to aspects the present invention may be prepared by a thermal chemical vapor deposition (CVD), a direct current (DC) plasma CVD, a radio frequency (RF) plasma CVD, or a microwave plasma CVD.

The carbide-driven carbon may be a compound of carbon and an element of Groups 2, 4, 13, 14, 15, and 16 in the Periodic Table of Elements, for example. Specifically, the carbide-driven carbon may be a diamond-based carbide, such as silicon carbide (Si—C) or boron carbide (B—C); a metallic carbide, such as titanium carbide (Ti—C) or zirconium carbide (Zr—C); a salt-based carbide, such as aluminum carbide (Al—C) or calcium carbide (Ca—C); a complex carbide, such as titanium-thallium carbide (Ti—Tl—C) or molybdenum tungsten carbide (Mo—W—C); a carbonitride, such as titanium carbonitride (Ti—C—N) or zirconium carbonitride (Zr—C—N); or a mixture thereof, but is not limited thereto.

In aspects of the present invention, the content of the carbonaceous compound of the water-based composition may be in a range of 10 to 200 parts by weight based on 100 parts by weight of the silicate compound. When the content of the carbonaceous compound is less than 10 parts by weight, a conductive network thereof is unstable and the light (or electron)-emitting performance of the electron emitter using the water-based composition may be degraded. On the other hand, when the content of the carbonaceous compound is greater than 200 parts by weight, a field enhancement property thereof is decreased due to a screen effect, and thus, the light (or electron)-emitting performance of the electron emitter using the water-based composition may be degraded.

Meanwhile, a counter ion (enabling charge neutrality) of the silicate compound of the water-based composition may be a metallic element of Groups 1, 2 and 13, for example. The silicate compound may be, but is not limited to, lithium silicate, potassium silicate, calcium silicate, aluminum silicate, boron silicate, magnesium silicate, or sodium silicate, specifically, lithium silicate, potassium silicate, aluminum silicate, magnesium silicate, sodium silicate, or a mixture thereof, though such is not required. The silicate compound of the water-based composition may have a solid phase or a liquid phase, specifically, the liquid phase, though such is not required.

The water of the water-based composition can be any type of water with any degree of purity. The water can be distilled water, deionized water, or ultrapure water, specifically, deionized water, though such is not required. The content of deionized water of the water-based composition may be in a range of 1500 to 1700 parts by weight based on 100 parts by weight of the silicate compound. When the content of deionized water is less than 1500 parts by weight, the viscosity of the water-based composition may increase and uniform coating thereof cannot be obtained. On the other hand, when the content of deionized water is greater than 1700 parts by weight, precipitation may occur.

In aspects of the present invention, the water-based composition may further include, in addition to the carbonaceous compound, the silicate compound and the water, other additives in an appropriate or predetermined amount, such as a pH controller, an organic binder, a surfactant, a thixotropic agent, or a material for improving dispersing and coating characteristics of the components or the composition.

In aspects of the present invention, the pH controller stabilizes the dispersed state and controls the pH thereof. Specifically, the pH controller may be ammonium hydroxide, ammonium nitrate, or sodium citrate (Na-Citrate), but is not limited thereto. The content of the pH controller may be adjusted such that the pH of the water-based composition is in a range of 8 to 11. When the pH of the water-based composition is less than 8, carbon particles are re-agglomerated and precipitate. On the other hand, when the pH of the water-based composition is greater than 11, carbon particles are also re-agglomerated and precipitate, and a processability of the water-based composition may be decreased due to a strong alkali condition thereof.

In aspects of the present invention, the organic binder prevents or reduces moisture from evaporating quickly, improves a state of dispersion, and stabilizes the water-based composition. The organic binder may be hydroxy ethyl cellulose, carboxy methyl cellulose, or hydroxy methyl cellulose, but is not limited thereto. The content of the organic binder may be in a range of 15 to 25 parts by weight based on 100 parts by weight of the silicate compound. When the content of the organic binder is less than 15 parts by weight, the stability of the water-based composition may be degraded. On the other hand, when the content of the organic binder is greater than 25 parts by weight, the viscosity of the water-based composition may be increased, and the processability of the water-based composition may be degraded.

In aspects of the present invention, the surfactant may be a cation-type surfactant, an anion-type surfactant, a betaine-type surfactant, or a non-ionic type surfactant. Specifically, the surfactant may be glycerin fatty acid ester, polyoxyethylene alkyl ether, alkyl sulfonic acid salt, alkyl phosphate, tetraalkylammonium salt, or alkylimidazolium betaine, but is not limited thereto. The content of the surfactant may be in a range of 25 to 35 parts by weight based on 100 parts by weight of the silicate compound. When the content of the surfactant is less than 25 parts by weight, carbon particles may be incompletely attached to a substrate. On the other hand, when the content of the surfactant is more than 35 parts by weight, the light-emission characteristics of the electron emitter using the water-based composition may be degraded.

In aspects of the present invention, the thixotropic agent may control the viscosity thereof, and may be clay, metal oxide colloid, fumed metal oxide, or a mixture thereof. Specifically, the thixotropic agent may be CAB-O-SIL® TS-530 treated fumed-silica (hexamethyl disiloxane-treated hydrophobic fumed silica), CAB-O-SIL®TS-610 treated fumed silica (dimethyl dichlorosilane treated hydrophobic fumed silica), an acryl-based compound, or an urethane-based compound, but is not limited thereto. The content of the thixotropic agent may be in a range of 3 to 5 parts by weight based on 100 parts by weight of the silicate compound. When the content of the thixotropic agent is less than 3 parts by weight, the stability of storage thereof may be decreased. On the other hand, when the content of the thixotropic agent is greater than 5 parts by weight, the dispersing characteristics thereof may be degraded.

In aspects of the present invention, the material for improving the state of dispersion and coating may be natural rubber, hydroxy methyl cellulose, hydroxy ethyl cellulose, or carboxy methyl cellulose, but is not limited thereto.

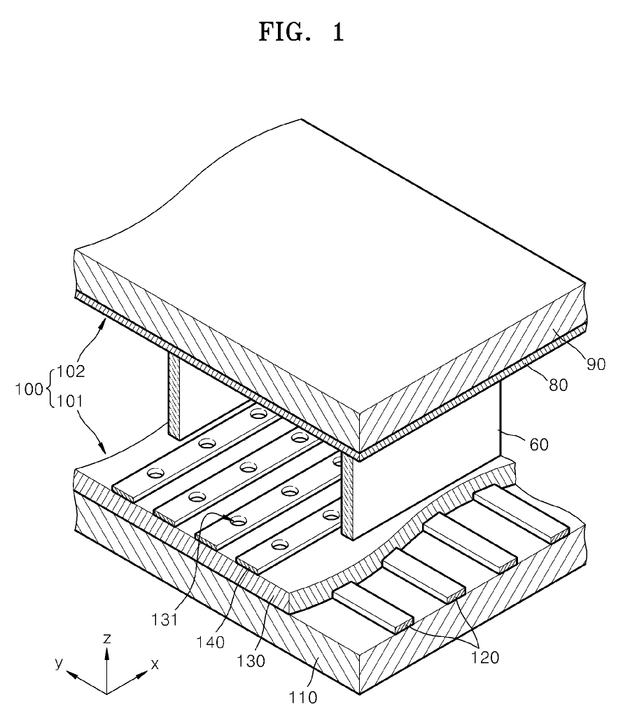

FIG. 1 is a schematic perspective view of a typical top gate-type electron emission display apparatus 100. Referring to FIG. 1, the typical top gate-type electron emission display apparatus 100 includes an electron emission device 101, a front panel 102 disposed to be parallel to the electron emission device 101 so as to define a vacuum emission space therebetween, and a spacer 60 to separate the electron emission device 101 from the front panel 102 by a predetermined distance.

The electron emission device 101 includes a first substrate 110, gate electrodes 140, and cathode electrodes 120 which extend to cross each other on the first substrate 110, and an insulating layer 130 interposed between the gate electrodes 140 and the cathode electrodes 120 to electrically insulate the gate electrodes 140 from the cathode electrodes 120. An electron emitter hole 131 is formed in each of the intersection portions of the gate electrodes 140, at which the gate electrodes 140 intersect with the cathode electrodes 120, and an electron emitter (not shown) is positioned in the electron emitter hole 131. The front panel 102 includes a second substrate 90, an anode 80 formed on a bottom surface of the second substrate 90, and a phosphor layer (not shown) formed on a bottom surface of the anode 80.

The water-based composition according to an aspect of the present invention is used to form a gap between electron emitters or a gap between an electron emitter and an electrode so as to obtain a distinctive (or a cleanly delineating) pattern. The water-based composition is used to form a lateral-gate electron emitter, or a line (or local) dimming electron emitter. However, the water-based composition can also be used for other types of electron emitters.

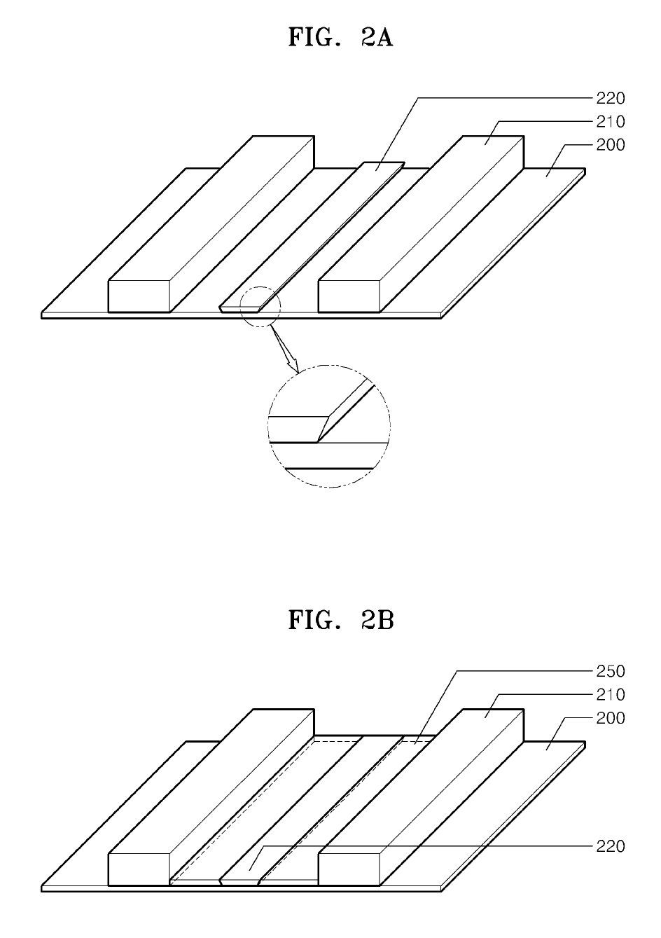

Hereinafter, the application of the water-based composition according to an aspect of the present invention will be described in detail with reference to a lateral-gate electron emitter and FIGS. 2A through 2 C. FIG. 2A is a perspective view of a lift-off type photoresist 220 coated between electrode patterns 210 formed on a substrate 200, and an enlarged view of a cross section of the lift-off type photoresist 220. Referring to FIG. 2A, a photoresist is coated on the substrate 200 on which the electrode patterns 210 are formed, and then the resultant structure is exposed to ultra-violet (UV) light having a center wavelength of 365 nm to 435 nm at 100 mJ/m². Then, the exposed substrate 200 undergoes hard baking, flood-exposure, and then is developed to form the lift-off type photoresist 220. Thus, a cross-section of the lift-off type photoresist 220 has angled edges that narrow towards the substrate 200 to aid the lift-off of the type photoresist 220, in this aspect, though such is not required.

FIG. 2B is a perspective view of an electron emitter coated on the substrate 200 on which the electrode patterns 210 are formed. Referring to FIG. 2B, after the processes as described with reference to FIG. 2A, a water-based composition 250 that is used to form an electron emitter is coated on a resultant structure by using a coating device (not shown). After the water-based composition 250 is coated, a drying process is performed.

FIG. 2C is a perspective view of an electron emitter 350 formed by lifting off the lift-off type photoresist 220, and an enlarged view of a cross section of the electron emitter 350, according to an aspect of the present invention. Referring to FIG. 2C, a cross section of the electron emitter 350 corresponds to a cross section of the lift-off type photoresist 220 illustrated in FIG. 2A. That is, the angled edges of the lift-off type photoresist 220 enables formation of corresponding angled edges of the electron emitter 350. As shown in FIG. 2C, the angled edges of the electron emitter 350 narrow away from the substrate 200, in this aspect, though such is not required. In other aspects, the edges of the electron emitter 350 may not be angled and instead, be essentially vertical relative to the substrate 200.

The lift-off type photoresist 220 is not compatible (e.g., does not adhere) with the water-based composition 250 that is used to form an electron emitter 350, because the lift-off type photoresist 220 is primarily formed of an organic component, while the water-based composition 250 is water based. Such incompatibility (or non adherence) between the water-based composition 250 and the lift-off type photoresist 220 can be maintained when the coating and the drying of the water-based composition that is used to form the electron emitters are performed after the lift-off type photoresist 220 is formed. Therefore, the lift-off type photoresist 220 can be completely separated from the electron emitter 350 during the lift-off process following the drying. Thereafter, a sintering process is performed to obtain a desired electron emitter pattern. FIG. 2D is a sectional view of the electron emitter 350 formed through the processes described above with reference to FIGS. 2A through 2C.

In aspects of the present invention, the electron emitter 350, prepared using the water-based composition that is used to form an electron emitter according to aspects of the present invention, includes a carbonaceous compound and a silicate compound. The carbonaceous compound may be carbon nanotubes or carbide-driven (or based) carbon, or a mixture thereof.

Carbon nanotubes are an allotrope of carbon that includes graphite sheets rolled up to a nano-size diameter to form a tube or a tube-like shape, and may be single wall (or sheet) nanotubes, multi wall (or sheets) nanotubes, or a mixture thereof, but are not limited thereto.

The carbide-driven carbon may be a compound of carbon and an element of Groups 2, 4, 13, 14, 15, and 16 in the Periodic Table of Elements, for example. Specifically, the carbide-driven carbon may be a diamond-based carbide, such as silicon carbide (Si—C) or boron carbide (B—C); a metallic carbide, such as titanium carbide (Ti—C) or zirconium carbide (Zr—C); a salt-based carbide, such as aluminum carbide (Al—C) or calcium carbide (Ca—C); a complex carbide, such as titanium-thallium carbide (Ti—Tl—C) or molybdenum tungsten carbide (Mo—W—C); carbonitride, such as titanium carbonitride (Ti—C—N) or zirconium carbonitride (Zr—C—N); or a mixture thereof, but is not limited thereto.

The content of the carbonaceous compound of the electron emitter 350 may be in a range of 30 to 130 parts by weight based on 100 parts by weight of the silicate compound. When the content of the carbonaceous compound is less than 30 parts by weight, the conductive network thereof is unstable and the light (or electron)-emitting performance of the emitter may be degraded. On the other hand, when the content of the carbonaceous compound is greater than 130 parts by weight, a field enhancement property thereof is decreased due to a screen effect, and thus, the light (or electron)-emitting performance of the emitter may be degraded.

A counter ion of the silicate compound may be a metallic element of Groups 1, 2 and 13, for example. The silicate compound may be, but is not limited to, lithium silicate, potassium silicate, calcium silicate, aluminum silicate, boron silicate, magnesium silicate, or sodium silicate, specifically, lithium silicate, potassium silicate, aluminum silicate, magnesium silicate, sodium silicate or a mixture thereof. The silicate compound has a solid phase because the silicate compound has been sintered, though such is not required.

An electron emission device according to an aspect of the present invention includes an electron emitter including a carbonaceous compound and a silicate compound. The carbonaceous compound and the silicate compound are the same as the carbonaceous compound and the silicate compound as described above.

Aspects of the present invention will be described in further detail with reference to the following examples. These examples are for illustrative purposes only and are not intended to limit the scope of the present invention. In examples and comparative examples below, compounds, a mixer, a coating device, and an analyzing device are not limited and can be any types used in the art.

### EXAMPLE 1

Preparation of a Water-Based Composition that is Used to Form an Electron Emitter

7.3 g of carbide-driven (or based) carbon, 79.5 g of deionized water, 5 g of potassium silicate, 4 g of ammonium hydroxide, 1 g of hydroxy ethyl cellulose, 1.5 g of surfactant (alkyl phosphate), 0.2 g of thixotropic agent (acryl-based compound), 1 g of natural gum, and 0.5 g of hydroxy methyl cellulose were added to a mixer and mixed together at 500 rpm for 30 minutes to obtain a water-based composition that is used to form an electron emitter according to an aspect of the present invention.

Preparation of an Electron Emitter

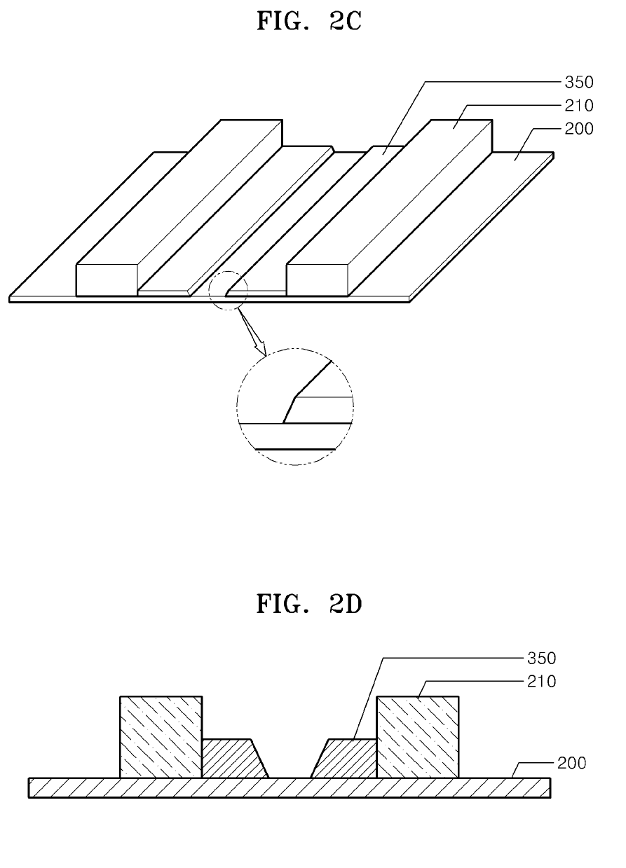

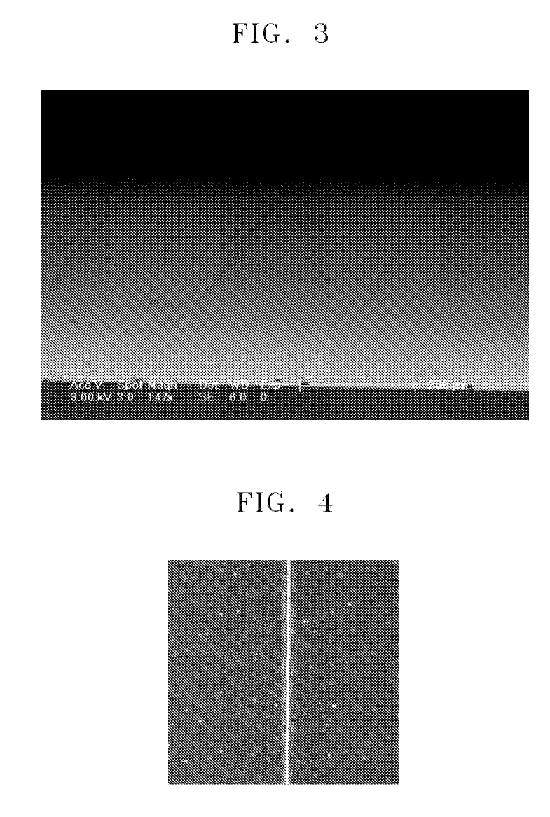

A pattern of a lift off-type photoresist was formed on a lateral-gate type cathode substrate, and then the water-based composition that is used to form an electron emitter was coated thereon. FIG. 3 is a scanning electron microscopic (SEM) image of a photoresist pattern coated with a water-based composition that is used to form an electron emitter according to an aspect of the present invention. Then, the resultant substrate was sintered at 450° C. for 30 minutes, and then the lift off-type photoresist was removed to form an electron emitter according to an aspect of the present invention. FIG. 4 is an optical image of electron emitters facing each other after the lift off-type photoresist was removed (magnified 300 times). Referring to FIG. 4, a gap is distinctively seen between electron emitters.

The residual carbon of the electron emitter was about 0.1% (based on 100% of the water-based composition excluding the silicate compound.)

Preparation of Electron Emission Device

An electron emission device was manufactured using an ITO glass (or an ITO coated glass) substrate on which the electron emitter is formed acting as a cold cathode, a 100 μm-thick polyethyleneterephthalate film acting as a spacer, and a copper plate acting as an anode.

### EXAMPLE 2

A water-based composition that is used to form an electron emitter, an electron emitter and an electron emission device were manufactured in the same manner as in Example 1, except that carbon nanotubes were used instead of the carbide-driven carbon. The residual carbon of the electron emitter was 0.1%.

### EXAMPLE 3

A water-based composition that is used to form an electron emitter, an electron emitter and an electron emission device were manufactured in the same manner as in Example 1, except that 3.65 g of carbide-driven carbon and 3.65 g of carbon nanotubes were used instead of only the carbide driven carbon. The residual carbon of the electron emitter was less than 0.1%.

### COMPARATIVE EXAMPLE 1

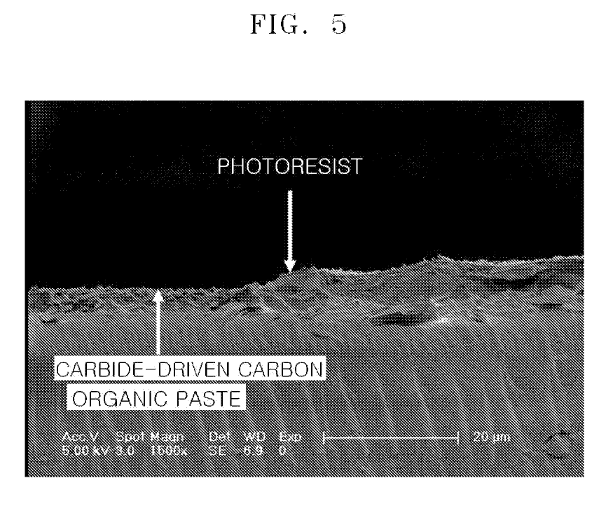

1 g of carbide-driven carbon, 6.5 g of acrylate binder, 5.5 g of trimethyolpropane ethoxytriacrylate (TMPEOTA), 5.5 g of texanol, 1 g of benzophenone, and 0.5 g of dioctylphthalate (DOP) were mixed together and homogeneously dispersed using a three-roll mill, thereby preparing an organic composition that is used to form an electron emitter. Then, a gap between electron emitters was formed in the same manner as in Example 1. However, as illustrated in FIG. 5, a chemical reaction occurs at the interface between the electron emitter and the photoresist, and thus, the interface was not distinctively distinguished or cleanly delineated. Thus, when the photoresist was removed, the electron emitter or portions thereof was removed as well. Therefore, a desired structure was not obtained. The residual carbon of the electron emitter was 1.5%.

### COMPARATIVE EXAMPLE 2

An organic composition that is used to form an electron emitter was prepared in the same manner as in Comparative Example 1, except that the carbon nanotubes were used instead of the carbide-driven carbon. The obtained organic composition was screen-printed on a lateral gate-type cathode substrate as the one in Example 1, and dried at 60° C. for 25 minutes to remove the solvent used. Then, the resultant structure was exposed to UV having the central wavelength of 365 nm to 435 nm at 500 mJ/m² and developed using an alkali compound to form a pattern. Then, the developed product was sintered at 450° C. for 30 minutes to remove the organic compounds, thereby obtaining an electron emitter. The residual carbon of the electron emitter was 1.5%.

Then, an electron emission device was manufactured using the electron emitter acting as a cold cathode, a 100 μm-thick polyethyleneterephthalate film acting as a spacer, and a copper plate acting as an anode.

Performance Test of Electron Emission Devices

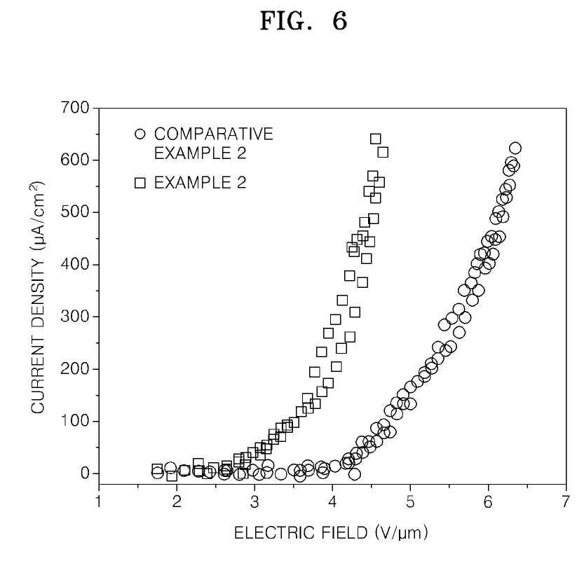

The current density and operating voltage of the electron emission devices prepared according to Example 2 and Comparative Example 2 were measured. The turn-on field of the electron emission device prepared using the water-based composition was 2.7 V/μm, and the turn-on filed of the electron emission device prepared using the organic composition was 3.8 V/μm. The current density of the electron emission device prepared using the water-based composition and the electron emission device prepared using the organic composition was able to reach 600 μA/cm² at an electrical field of 4.3 V/μm and 6.2 V/μm, respectively. The results are shown in FIG. 6. Therefore, it can be seen that the electron emission device prepared according to Example 2 has better electron emission performance than the electron emission device prepared according to Comparative Example 2.

Lifetime Test

The electron emission lifetime of the electron emitters prepared according to Example 2 and Comparative Example 2 was measured to identify lifetime characteristics. The results are shown in Table 1. Referring to Table 1, it can be seen that the electron emitter prepared using the water-based composition has a much smaller residual carbon content and a longer lifetime than those of the electron emitter prepared using a typical organic composition.

TABLE 1

| | Electron emitter | | Content of |
|---|---|---|---|
| | composition | Lifetime | residual carbon |
| Example 2 | Water-based composition | 4500 hours | 0.1 (%) |
| Comparative | Organic composition | 1500 hours | 1.5 (%) |
| Example 2 | | | |

The lifetime was measured by assuming a time at the current of 0.5 mA/cm² using a graph of current measured in a time period of 500 hours. In this regard, the initial current was 1 mA/cm². In general, an electron emission current is quickly decreased over time but is gradually saturated and then maintained at a predetermined level after a predetermined period of time. The saturated line was extrapolated to obtain the electron emission current after 500 hours.

According to aspects of the present invention, the residual carbon of the electron emitter may be less than 1%, and may even be less than about 0.1% (based on 100% of the water-based composition excluding the silicate compound.)

In various aspects, at least one of refers to alternatives chosen from available elements so as to include one or more of the elements. For example, if the elements available include elements X, Y, and Z, at least one of refers to X, Y, Z, or any combination thereof.

According to aspects of the present invention, a water-based composition that is used to form an electron emitter is suitable for forming a distinctive (or cleanly delineated) pattern, and an electron emitter formed using the water-based composition has a very small residual carbon content. Therefore, an electron emission device including the electron emitter has a high performance and a long lifetime.

Although a few aspects of the present invention have been shown and described, it would be appreciated by those skilled in the art that changes may be made in the aspects without departing from the principles and spirit of the invention, the scope of which is defined in the claims and their equivalents.

What is claimed is:

1. A water-based composition that is used to form an electron emitter, the composition comprising:
a carbonaceous compound;
a silicate compound; and
water.

2. The water-based composition of claim 1, wherein the carbonaceous compound is selected from the group consisting of carbon nanotubes, carbide-driven carbon, and a mixture thereof.

3. The water-based composition of claim 1, wherein the content of the carbonaceous compound is in a range of 10 to 200 parts by weight based on 100 parts by weight of the silicate compound.

4. The water-based composition of claim 1, wherein the silicate compound comprises, as a counter ion, a metallic element of Groups 1, 2 and 13 in the Periodic Table of Elements.

5. The water-based composition of claim 1, wherein the silicate compound is selected from the group consisting of lithium silicate, potassium silicate, aluminum silicate, magnesium silicate, sodium silicate, and a mixture thereof.

6. An electron emitter of a field emitter array (FEA) electron emission device, comprising:
a carbonaceous compound; and
a silicate compound.

7. The electron emitter of claim 6, wherein the carbonaceous compound is selected from the group consisting of carbon nanotubes, carbide-driven carbon, and a mixture thereof.

8. The electron emitter of claim 6, wherein the content of the carbonaceous compound is in a range of 30 to 130 parts by weight based on 100 parts by weight of the silicate compound.

9. The electron emitter of claim 6, wherein the silicate compound comprises, as a counter ion, a metallic element of Groups 1, 2 and 13 in the Periodic Table of Elements.

10. The electron emitter of claim 6, wherein the silicate compound is selected from the group consisting of lithium silicate, potassium silicate, aluminum silicate, magnesium silicate, sodium silicate, and a mixture thereof.

11. An electron emission device comprising the electron emitter of claim 6.

12. A field emitter array (FEA) electron emission device, comprising:
a substrate;
electrode patterns formed on the substrate; and
an electron emitter formed from a water based composition, and having a gap formed by removal of a photoresist.

13. The device of claim 12, wherein edges of the electron emitter are angled so that the edges narrow away from the substrate.

14. The device of claim 12, wherein the water based composition is formed by combining a carbonaceous compound, a silicate compound, and water.

15. The device of claim 14, wherein
the carbonaceous compound is selected from the group consisting of carbon nanotubes, carbide-driven carbon, and a mixture thereof, and
the silicate compound is selected from the group consisting of lithium silicate, potassium silicate, aluminum silicate, magnesium silicate, sodium silicate, and a mixture thereof.

16. The device of claim 15, wherein the carbon nanotubes are sheets of carbon rolled up to a nano-size diameter to form a tube-like shape, and includes single sheet nanotubes, multi sheet nanotubes, or a mixture thereof.

17. The device of claim 15, wherein the carbide-driven carbon is at least one of silicon carbide (Si—C), boron carbide (B—C), titanium carbide (Ti—C), zirconium carbide (Zr—C), aluminum carbide (Al—C), calcium carbide (Ca—C), titanium-thallium carbide (Ti—Tl—C), molybdenum tungsten carbide (Mo—W—C), titanium carbonitride (Ti—C—N), zirconium carbonitride (Zr—C—N), or a mixture thereof.

18. The device of claim 14, wherein a residual carbon in the electron emitter is less than about 0.1% based on 100% of the water-based composition excluding the silicate compound.
